(19) United States
(12) Patent Application Publication
(10) Pub. No.: US 2006/0113425 A1
(43) Pub. Date: Jun. 1, 2006

(54) Vertical take-off and landing aircraft with adjustable center-of-gravity position

(76) Inventor: Hermann Rader, Wurzburg (DE)

Correspondence Address: EDWIN D. SCHINDLER, FIVE HIRSCH AVENUE, P.O. BOX 966, CORAM, NY, 11727-0966, US

(21) Appl. No.: 11/165,934

(22) Filed: Jun. 24, 2005

(30) Foreign Application Priority Data
Jun. 24, 2004 (EP) EP 04 014 785.2
Jan. 17, 2005 (DE) 10 2005 002 225.1

(51) Int. Cl. B64C 27/00

(52) U.S. Cl. 244/17.11

(57) ABSTRACT

A vertical take-off and landing aircraft includes a device for generating lift, which includes at least one drivable rotor, which is mounted to be rotatable about a rotor pivot axis, which extends parallel to the vertical axis of the aircraft. The aircraft further includes a device for generating propulsion, which displaces the center of gravity of the aircraft within a plane running normal to the rotor pivot axis.

The invention relates to a vertical take-off and landing aircraft comprising means for generating lift, which comprise at least one drivable rotor, which is mounted so as to be rotatable about a rotor pivot axis, which extends parallel to the vertical axis of the aircraft, as well as means for generating propulsion, according to the generic portion of claim 1.

Vertical takeoff and landing aircraft currently typically take the form of helicopters having a drivable rotor, which is arranged so as to be rotatable about a rotor pivot axis, which extends parallel to the vertical axis of the helicopter Helicopters are used wherever a precise manoeuvrability in an extremely small space, the capability to reduce the airspeed to standstill, and the capability for vertical takeoff and landing are required, for example in the field of air rescue, in the military sector or for police assignments.

The propulsion in the case of such a helicopter is generated either by tilting the rotor with respect to the fuselage of the helicopter from the perpendicular in the desired direction of flight or by a cyclic rotor blade adjustment, in which the rotor blades, simultaneously with their rotation, execute a tilting movement in a particular, controllable turning range, with an increase of the angle of attack and thereby of the lift coefficient and resistance coefficient. The increased resistance coefficient with the cyclic rotor-blade adjustment effects a propulsion thrust and thereby a movement of the helicopter through the air.

The disadvantage of this prior art is that because of the principle of propulsion generation, the maximum achievable airspeed and the maximum flying range are limited. Moreover, on the failure of only one control device, the manoeuvrability of known helicopters is no longer assured. Furthermore, the principle of propulsion generation results in very high maintenance costs as a result of the necessary high number of wear parts.

The object of the invention is therefore to develop an improved vertical takeoff and landing aircraft.

The object is achieved in the case of a device of the generic type mentioned at the outset by means for displacing the centre of gravity of the aircraft within a plane extending normal to the rotor pivot axis.

By displacing the centre of gravity of the aircraft in its longitudinal direction, a pitching motion of the aircraft about its transverse axis can be generated. By displacing the centre of gravity of the aircraft perpendicular to its longitudinal direction, a rolling motion of the aircraft about its longitudinal axis can be generated. By means of the pitching and/or rolling of the aircraft caused by a displacement of the centre of gravity, the rotor downdraught generated by the rotor is analysed into a vertical lift component and into a horizontal propulsion component, whereby the aircraft can execute a horizontal movement in the air. In this case, the means for displacing the centre of gravity of the aircraft represent additional means for generating propulsion. Moreover, the means for displacing the centre of gravity of the aircraft can be used to generate a stable attitude with additional means mounted on the aircraft for lift generation, in particular with aerofoils arranged on the aircraft and additional means, independent of the rotor, for generating propulsion. By this means, it is conceivable to create an aircraft, which can takeoff and land by means of one or more rotors, for example in the case of long-range flights the drive of the rotor disconnecting after a particular minimum airspeed has been achieved and the propulsion being generated, for example, by means of a propeller, the lift generation taking place by via the aerofoils. Here the position of the centre of gravity necessary for a stable attitude is different for lift generation by means of a rotor than for lift generation by means of aerofoils.

The aircraft according to the invention has the advantage over the prior art that propulsion generation is possibly by very easily implemented means. Moreover, it is possible, with the aircraft according to the invention, to combine different variants of propulsion and lift generation—each of which is known independently, since the capability to displace the centre of gravity permits, for example, an arrangement of aerofoils, which, in the case of long-range flight, are solely responsible for lift generation.

To realise the concept according to the invention, the concrete form of the implementation is free within wide limits. One of the particularly preferred solutions consists in displacing the engine block which, because of its relatively high weight, results in a large change of the moment for relatively small displacement distances. It is conceivable to further increase the weight of the engine by mounting a ballast tank, in case a higher weight is desired.

A possibility that can be realised alternatively or at the same time would also consist in displacing the tail engine, possibly together with the tail surface forwards or backwards.

Another possibility consists in displacing the seats in the cockpit or even the cockpit as a whole.

Finally, it is conceivable to provide a tank or reserve tank, which, when displaced, contributes to changing the centre of gravity. To make the moment independent of the tank level indicator, the displaceable reserve tank is connected via a fuel line to the higher main tank, and thus remains unchanged in its weight, and consequently in its effect on the centre of gravity. Finally it is also conceivable to mount an additional weight (lead weight), the position of which can be changed, and/or the tank with extinguisher powder, so as to be displaceable. All of these aforementioned measures can be combined with one another in order to obtain a pronounced effect.

For the implementation of the displacement, it is recommended to mount the object, of which the position of the centre of gravity can be changed, on rails and to carry out its relative movement with respect thereto. The displacement of the centre of gravity of the aircraft in the longitudinal direction takes place, for example, by means of at least one stepping motor, which displaces, for example, the drive engine of the rotor in the longitudinal direction of the aircraft. For easier determination of the centre of gravity, it is conceivable to arrange variable loads, such as, for example, the useful load and the fuel tank at a position in the longitudinal and transverse direction of the aircraft which lies in the normal trim position, principally in the centre of gravity of the aircraft. The crew of the aircraft, furthermore, form a variable load. For determining the influence of the weight of the crew on the centre of gravity position, it is conceivable to arrange, for example, pressure sensors in the cockpit, with which the weight of the crew can be determined.

An advantageous embodiment of the invention provides that the means for generating propulsion, in addition to the means for displacing the centre of gravity comprise at least one drivable propeller, which is arranged so as to be rotatable about a propeller axis running perpendicular to the rotor axis, can be driven independently of the rotor, and is preferably arranged on the tail of the aircraft.

One embodiment provides that the propeller has a collective blade adjustment.

A further embodiment is characterised by means for controlling the aircraft about its vertical axis, which runs parallel to the rotor pivot axis.

An advantageous embodiment of the invention provides that the means for controlling the aircraft about its vertical axis, which runs parallel to the rotor pivot axis, comprise a tilting device, which is tiltable about a tilt axis, which extends parallel to the rotor pivot axis, and on which at least the propeller is arranged. A tilting of the propeller about an axis running parallel to the rotor axis allows the propeller to be used both for generating a propulsion in straight-ahead flight as well as for controlling the aircraft about its vertical axis running parallel to the rotor pivot axis. The propeller preferably has a blade adjustment for adjusting the angle of attack of the propeller blades, and thereby the shear force of the propeller.

An expedient measure provides that the means for controlling the aircraft about its vertical axis, which runs parallel to the rotor pivot axis, comprise at least one vertical stabiliser surface, which is tiltable about an axis running parallel to the rotor pivot axis. The vertical stabilizer surface permits the control of the aircraft about its vertical axis in horizontal flight. By this means it is conceivable, in horizontal flight, to fix the rotor as from a certain airspeed such that the propeller pivot axis runs parallel to the longitudinal axis of the aircraft. The control about the vertical axis then takes place as with an aircraft with aerodynamically profiled aerofoils via the vertical stabilizer surface. It is also conceivable to pivot the propeller synchronously with the vertical stabiliser surface.

A further embodiment provides that the vertical stabilizer surface is part of a stabilizer system, which is preferably mounted on the tail of the aircraft.

Another advantageous embodiment of the invention provides that the means for generating propulsion additionally comprise at least one jet deflection flap suitable for deflecting the rotor downdraught. At this point it should again be pointed out that the term propulsion comprises forces in a horizontal direction, that is to say those forces that effect a movement of the aircraft in the direction of its transverse axis.

In an alternative measure, the means for generating lift additionally comprise aerodynamically profiled aerofoils arranged laterally on the aircraft.

Another advantageous embodiment is characterised by a means for controlling the aircraft about its transverse axis. Due to the arrangement of aerofoils on the aircraft, it is necessary for the aircraft to have means by which it can be controlled about its transverse axis. These means are necessary to allow, for example, a uniform lift force at different airspeeds to be generated by varying the angle of attack of the aerofoils with respect to the direction of flight.

In an additional measure, the means for controlling the aircraft about its lateral axis comprise the means for displacing the centre of gravity of the aircraft.

An additional, advantageous embodiment of the invention provides for the means for controlling the aircraft about its transverse axis to comprise at least one horizontal stabilizer surface, which is tiltable parallel to the transverse axis of the aircraft.

A further development provides that the horizontal stabilizer surface is part of a stabilizer system, which is preferably mounted on the tail of the aircraft. Here, it is conceivable to design the entire stabilizer system, comprising the vertical stabilizer surface and the horizontal stabilizer surface, so as to be tiltable together with the propeller.

A further advantageous possibility of the arrangement results from the tiltability of the tail engine about an axis parallel to the transverse axis and/or about an axis parallel to the vertical axis of the aircraft, preferably synchronously with the tiltability of the propeller, so that the propeller does not only generate propulsive thrust, but can also affect the control of the aircraft.

Further variants emerge when the transverse and/or vertical axis of the tail engine is far distant from its centre of gravity, because the centre of gravity of the tail engine, with respect to the entire aircraft, is then also additionally displaced in the longitudinal direction (forwards/backwards) and/or in the transverse direction (left/right).

In one embodiment, the rotor can be switched off when the airspeed exceeds a particular minimum value, and can be switched on again when the airspeed falls below a particular minimum value.

The switching off and switching on of the rotor is advantageously carried out automatically.

In another particularly advantageous embodiment, the rotor has a collective rotor blade adjustment for simultaneous variation of the angle of attack of all rotor blades of the rotor. The collective rotor-blade adjustment in particular permits autorotation landings if the rotor drive has failed.

The means for generating lift can comprise at least two drivable rotors which are preferably arranged so as to be rotatable about an essentially vertical rotor pivot axis in each case. By the use of two rotors preferably arranged on separate axes, means for compensating the drive moment of the rotors, for example a tail rotor, can be eliminated. The rotors here preferably rotate synchronously in opposite directions.

An advantageous, particularly advantageous embodiment of the invention provides that the means for generating propulsion additionally comprise a cyclic rotor-blade adjustment of the rotor, which takes place synchronously with the rotation of the rotor, for periodic adjustment of the angle of attack of the individual rotor blades of the rotor, independently of one another in a variable rotation range around the rotor pivot axis. The rotor blade adjustment comprises, for example, a swash plate.

An additional, particularly advantageous embodiment of the invention provides that the aircraft comprises a frame, which surrounds the rotor and has a circular rotor pivot opening, which is continuous in the direction of the rotor pivot axis and in which the rotor is arranged and rotates in a protected way. In addition, the flow conditions within the rotor cladding formed by the frame and the rotor pivot opening, in contrast to a freely turning rotor, is advantageously influenced by the selective shaping of the cross-sectional profile.

In a particularly advantageous, additional embodiment, the rotor pivot opening is flared divergently from the cross-section in which the rotor is located in the direction of flow of the downdraught. By means of the divergent flaring of the rotor pivot opening, a lowering of the flow velocity of the rotor downdraught, with simultaneous increase of the pressure in the outlet cross-section of the rotor pivot opening, is achieved, whereby the lift efficiency is improved and, in particular for use of the aircraft according to the invention for air rescue, the rotor downdraught is reduced.

Finally, a telescopic arm can be arranged on the aircraft. By means of the telescopic arm, the securing of objects and landing at poorly accessible and fissured points is possible.

### BRIEF DESCRIPTION OF THE DRAWING

wherein:

FIG. 1 shows: a perspective view of an aircraft according to the invention with telescopic arms arranged thereon, seen from the front

FIG. 2 shows: a perspective view of an aircraft according to the invention of FIG. 1 with removed rotors, seen from above

FIG. 3 shows: a perspective view of a cockpit of an aircraft according to the invention, seen from the front

FIG. 4 shows: a perspective view of a base construction with frame of an aircraft according to the invention, seen from above

FIG. 5 shows: a perspective view of an aircraft according to the invention from the front, with jet deflection flap that is swivelled in at one side

FIG. 6 shows: a perspective view of a cockpit of an aircraft according to the invention, seen from the front

FIG. 7 shows: a top view of an aircraft according to the invention

FIG. 8 shows: a perspective view of a cockpit of an aircraft according to the invention, seen from behind

FIG. 9 shows: a first perspective view of an aircraft according to the invention with aerodynamically profiled aerofoils arranged thereon, seen from the front

FIG. 10 shows: a second perspective view of an aircraft according to the invention with aerodynamically profiled aerofoils arranged thereon, seen from the front

FIG. 11 shows: a sketch of an engine support slide, which bears the drive engine of the rotors of an aircraft according to the invention and is displaceable in the longitudinal direction of the aircraft

FIG. 12 shows: a sketch of the drive train, which transmits the drive power of the drive engine, which is arranged on the displaceable engine bearing slide, to the rotors, and

FIG. 13 shows: a sketch of the arrangement of the drive of the tail propeller, which is arranged on the tail of the aircraft according to the invention

The same reference numbers in the description of the figures and in the drawing describe the same means, or means having the same effects.

### WAYS FOR IMPLEMENTING THE INVENTION

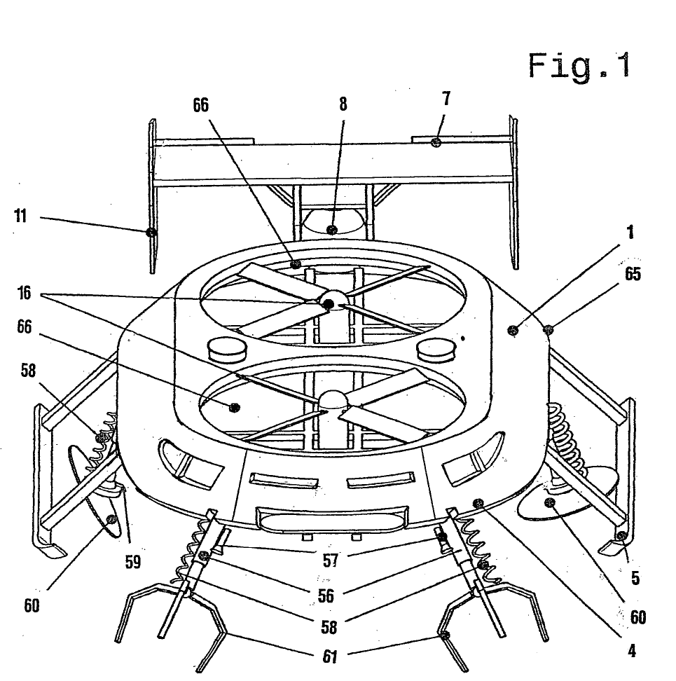

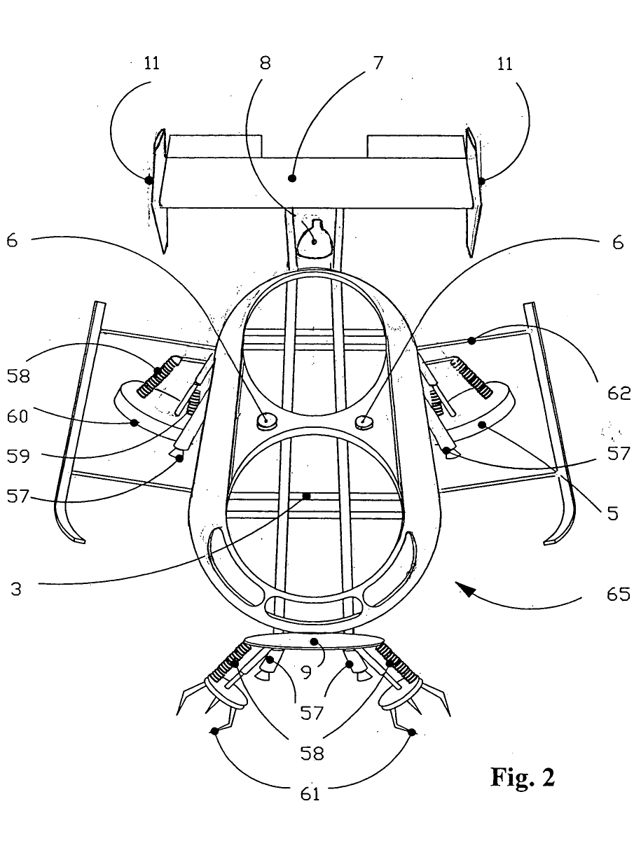

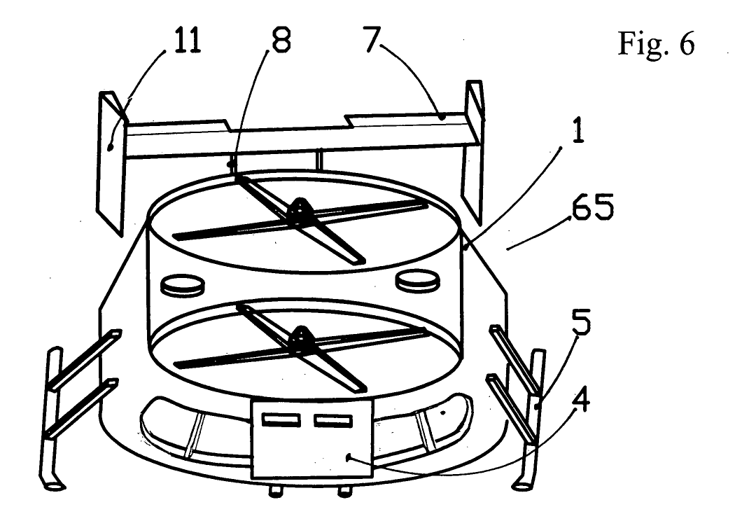

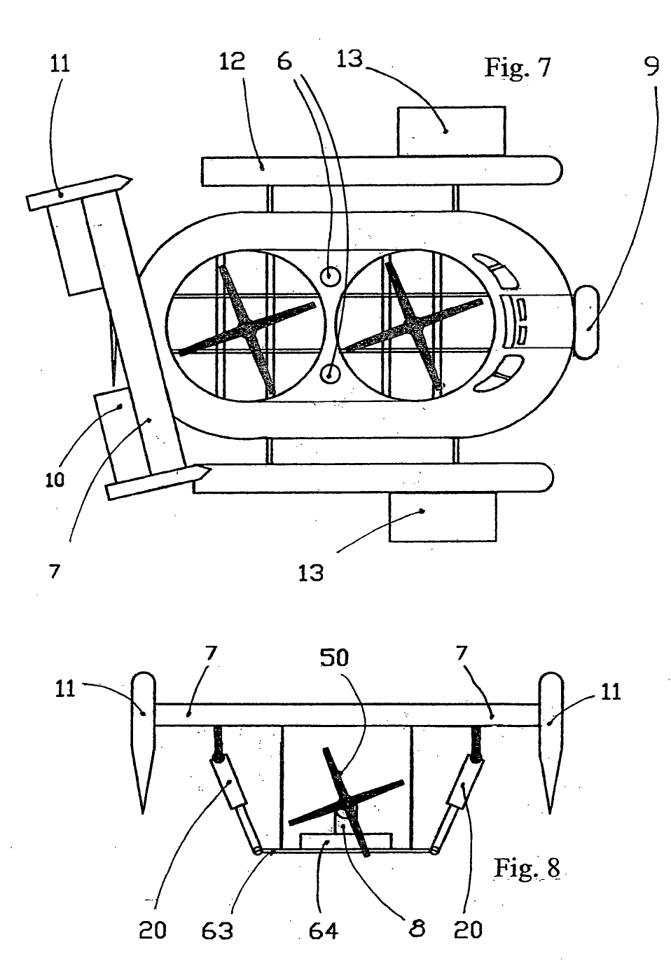

An aircraft 65 shown in FIGS. 1 to 13 consists essentially of a base construction with frame 1, two rotors 16, which are arranged in a rotor pivot opening 66 arranged in the frame 1 in each case, a drive engine 25 for the rotors 16, a tail propeller 50 with associated drive engine 8, a stabiliser system 7 comprising a vertical stabiliser surfaces 54 and a horizontal stabiliser surfaces 10, a cockpit 4 arranged behind the rotors, and means for displacing the centre of gravity of the aircraft 65.

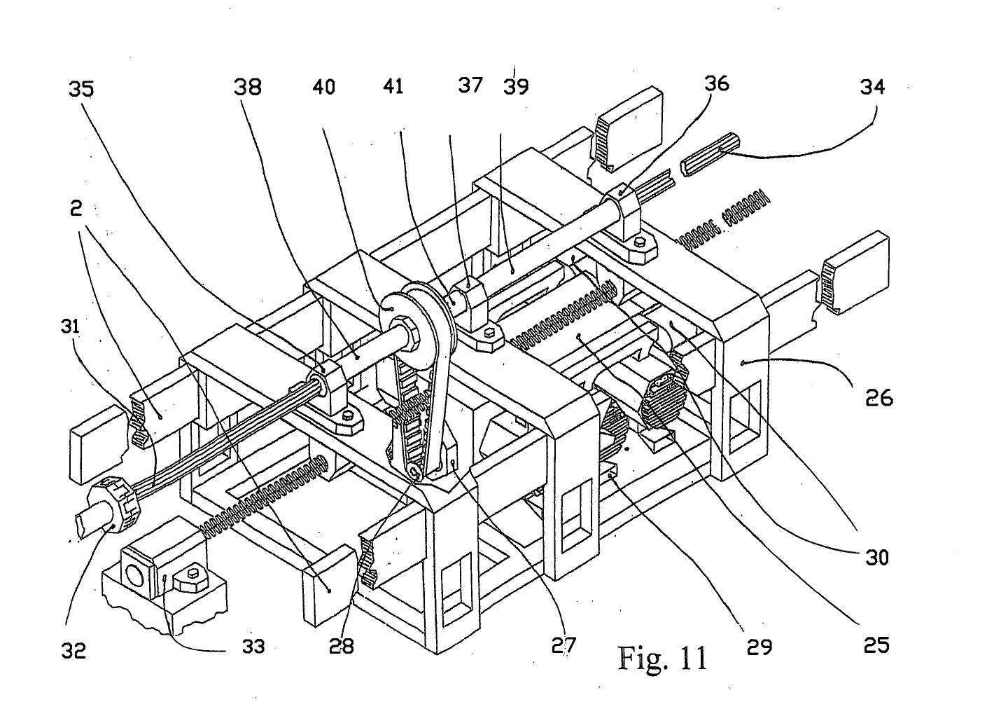

The gist of the invention is based on a displaceability of the centre of gravity of the aircraft 65. For determining the centre of gravity, it is provided to design the cockpit 4 of the aircraft 65 with a double floor. Between the double floors are located pressure sensors for determining the weight of the crew in the cockpit 4. With these data, an on-board computer can compute the centre of gravity of the aircraft 65. Before takeoff, the drive engines 25, which are arranged on an engine bearing slide 26, of the rotors 16 are displaced by means of a stepping motor 33 either forwards 48 or backwards 49 such that the aircraft 65 has a neutral trim. The engine bearing slide 26 is shown in FIG. 11. After the vertical lifting of the aircraft 65, the engine-bearing slide 26 is pushed in the desired direction of flight, for example forwards. By this means the centre of gravity of the aircraft 65 is displaced forwards and the aircraft 65 executes a pitching motion about its transverse axis. The rotor downdraught thereby has a horizontal component, by which means a propulsion is created and the aircraft 65 moves horizontally in the air.

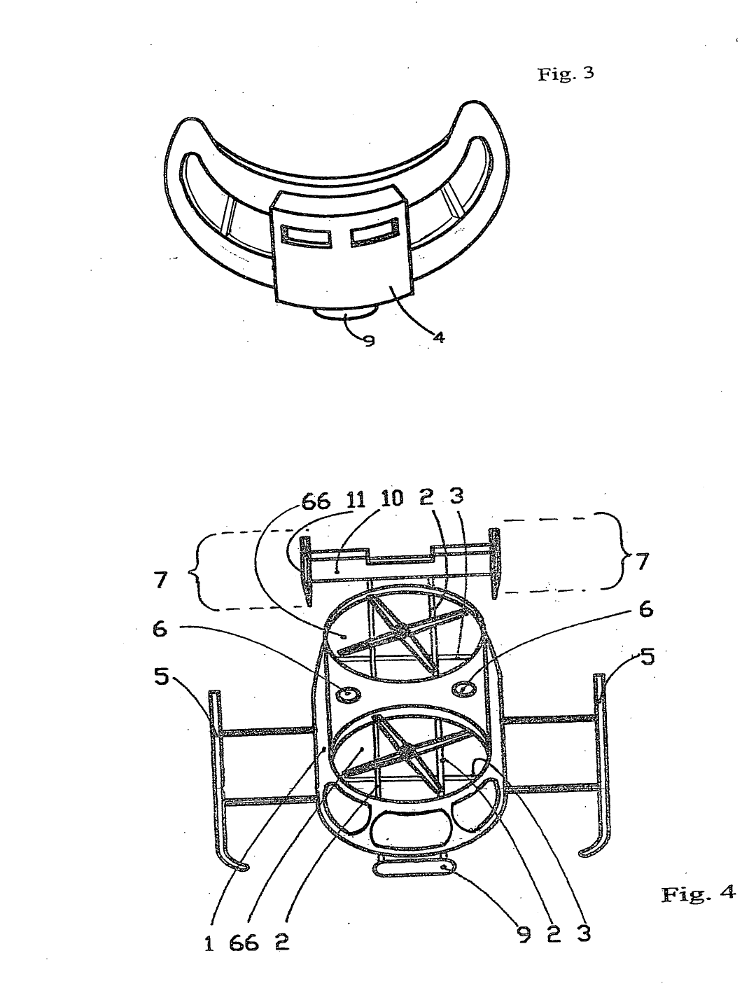

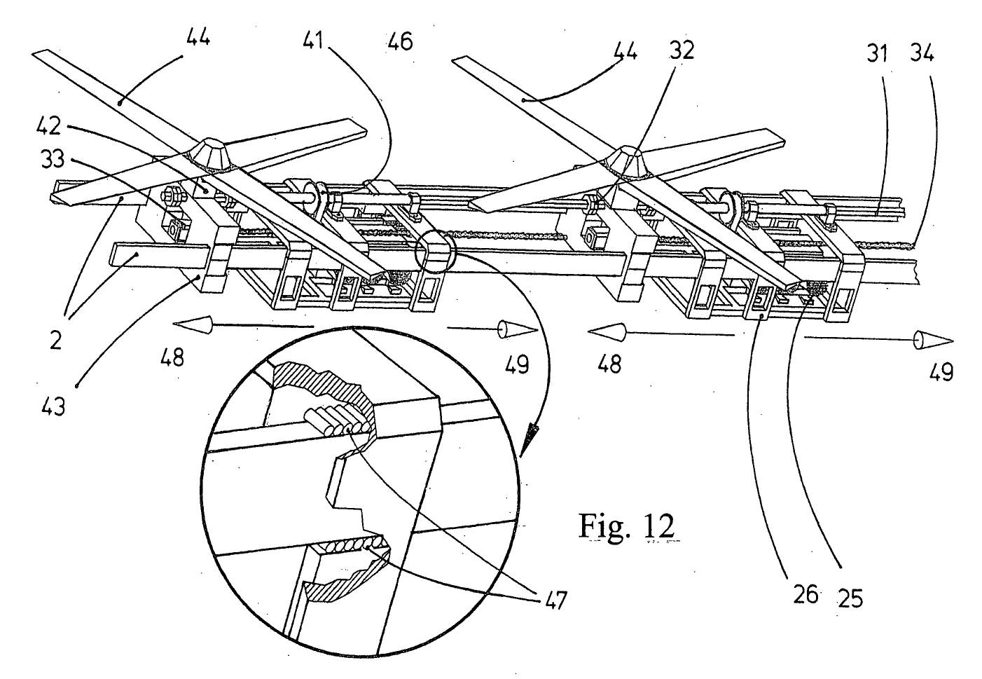

In FIG. 4, besides the base construction with frame 1, there can also be seen the main bearing rails 2, which are connected to the frame 1, on which the mechanism for displacing the centre of gravity of the aircraft 65 is arranged. Cross struts 3 form an additional connection to the frame 1. On both sides of the rotors 16, fuel tanks 6 are mounted between the rotors 16. On the front side of the main bearing rails 2, a support 9 for the cockpit 4 is arranged. The arrangement of the drive engine 25 on the engine bearing slide 26 is shown in FIGS. 11 and 12. A stepping motor 33 is arranged on the main bearing rails 2. The stepping motor 33 drives a spindle 34. Rotation of the spindle about its longitudinal axis effects a longitudinal displacement of the engine bearing slide 26, which is arranged so as to be longitudinally displaceable on the main bearing rails 2, along the longitudinal axis of the aircraft 65. For easier longitudinal displaceability of the engine bearing slide 26 along the main bearing rails, cylinder rollers 47 are arranged between the main bearing rails and the engine bearing slide 26. On the engine bearing slide 26, the drive engine 25, with the carburettor 29 and exhaust silencer 30, is arranged. The drive engine 25 drives a toothed belt pulley 28 via an oil coupling 27. The oil coupling 27 permits the disconnection of the engine 25 from the toothed belt pulley 28. By means of a toothed belt 46, the drive power of the engine 25 is transmitted from the toothed belt pulley 28 to a toothed belt pulley 41. The toothed belt pulley 41 is connected, so as to be interlocking and longitudinally displaceable, to a drive shaft 31, which is connected by means of an angular gear 42 to the rotors 16. The drive shaft 31 is preferably designed as a hexagonal or octagonal tube. The engine bearing slide 26 is also longitudinally displaceable with respect to the drive shaft 31. On the engine bearing slide 26 are arranged bearings 35, 36 and 37. Between bearings 35 and 37 is arranged the toothed-belt pulley 41. To fix the position of the toothed-belt pulley 41 with respect to the toothed-belt pulley 28, spacer sleeves 38 and 40 are arranged on the drive shaft, in each case between bearings 35 and 37 and the toothed-belt pulley, so as to be longitudinally displaceable. For stabilization, a spacer sleeve 39 is also arranged between bearing 36 and the bearing 37. By means of the bearings 35, 36 and 37 arranged on the engine bearing slide, and the spacer sleeves 38 39 and 40, which are arranged between the bearings and the toothed-belt pulley, upon longitudinal displacement of the engine bearing slide 26 along the drive shaft 31, the toothed-belt pulley 41 is also displaced along the drive shaft 31. The drive shaft 31 transmits the drive power of the drive engine 25 via a dog clutch 32 and the angular gear 42 to the rotors 16. The angular gear 42 is fixed by means of an angular gear mounting 43 on the main bearing rails 2. FIG. 12 furthermore shows the rotor blades 44 of the rotors 16.

The type of design allows the aircraft 65 to be controlled in various ways and through greater reliability better flying characteristics to be obtained.

The aircraft 65, besides the control by displacement of the centre of gravity, is additionally provided with a cyclic rotor blade adjustment by means of a swash plate, by means of which a second, redundant means for generating propulsion is created. In addition, jet deflection flaps 21, 22, 23 and 24 are provided, by means of which the rotor downdraught can be deflected to generate propulsion. By this means a third, redundant means for generating propulsion is created. The term propulsion here comprises all movement directions of the aircraft in a horizontal plane. Likewise it is conceivable to limit the means for propulsion generation to the displacement of the centre of gravity and the jet deflection flaps 21, 22, 23 and 24.

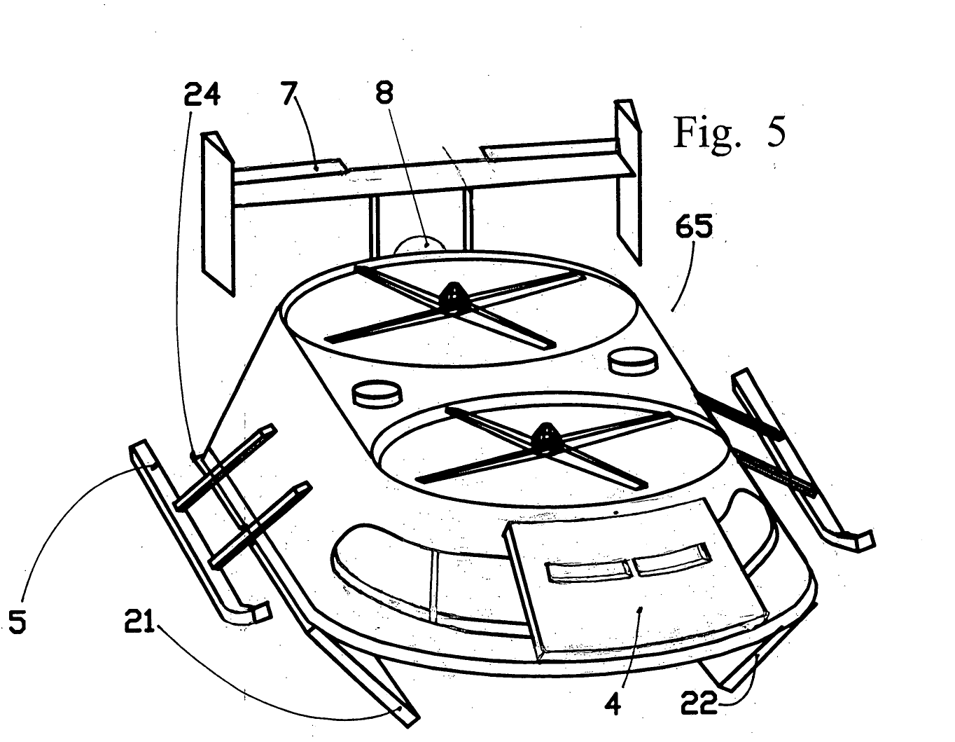

The jet deflection flaps 21, 22, 23 and 24 are preferably arranged on the runners 5 beneath the rotor pivot opening 66 at the outlet of the rotor downdraught from the frame 1. In FIG. 5, the arrangement of four jet deflection flaps 21, 22, 23 and 24 on the aircraft 65 is recognisable. The jet deflection flaps 21 and 24 are here pivoted into the rotor downdraught. By this means a lateral movement of the aircraft 65 to the left in FIG. 5 is generated. If, for example, the forward jet deflection flaps 21 and 22 are tilted inwards, while the rear jet deflection flaps 23 and 24 remain in a neutral or outwardly tilted position, a forward movement of the aircraft 65 is generated. Depending on the position of the jet deflection flaps 21, 22, 23 and 24, a movement of the aircraft 65 forwards or backwards, to the right or to the left, can be generated. The jet deflection flaps 21, 22, 23 and 24 may be controlled, for example, electrically, hydraulically, pneumatically or mechanically independently of one another. By means of the jet deflection flaps 21, 22, 23 and 24, the rotor downdraught is deflected, causing the aircraft 65 to execute a rightward or leftward movement.

On the tail of the aircraft 65 is located the stabiliser system 7, and in the centre, arranged on a tilting device 64 running parallel to the rotor pivot axis, is located the drive engine 8 for the tail propeller 50. The tail propeller 50 drives the aircraft 65 in straight-ahead flight. When aerodynamically profiled aerofoils 14 are fitted, in straight-ahead flight and when the minimum airspeed is exceeded, the rotors 16 are disconnected from the drive engine 25 and the angle of attack is reduced in order to achieve high airspeeds. In this range the aircraft 65 flies as a fixed-wing aircraft. It is also conceivable under these flying conditions to design the aircraft 65 as a gyrocopter, in which the rotors 16 are decoupled from the drive engine 25 and serve as aerofoils.

The airfoils 14 in this case are fixed to aerofoil receivers 13 on the base construction with frame 1. Cross struts 15 serve for stabilising the aerofoils 14. On the aerofoils, control surfaces 18 are arranged, for example for use as ailerons. The possibility of using the aircraft 65 simultaneously as a vertical takeoff and landing aircraft 65 with rotors 16 and as a fixed-wing aircraft is only made possible at all by the possibility of displacing the centre of gravity of the aircraft 65, since, for a stable attitude, a fixed-wing aircraft requires a different position of the centre of gravity than a vertical takeoff and landing aircraft 65 provided with rotors. The aerofoils 14 can be profiled and shaped according to the application of the aircraft 65. For long flying distances, for example, aerofoils 14 with a large extension are advantageous.

Due to the possibility of switching off the rotors 16 in conjunction with the use of aerodynamically profiled aerofoils 14 for lift generation, considerably greater airspeeds can be achieved than with a conventional helicopter. In straight-ahead flight, the rotors 16 are disconnected from the drive engine 25 and the aircraft 65 is only driven by the tail propellers 50. This measure saves fuel and permits higher velocities.

The tail propeller 50 has adjustable propeller blades, by which means an influencing of the airspeed is possible. Due to the possibility of tilting the tail propeller 50 together with the stabiliser system 7 by means of the tilting device 64 to the right and left, the aircraft 65 can be controlled about its vertical axis. The propeller blades are in this case preferably symmetrically profiled to be able to increase and reduce the speed of the aircraft 65 equally.

The tilting of the tilting device 64 and therefore of the tail propeller 50 and the stabiliser system 7 is carried out electrically hydraulically, pneumatically or mechanically. In FIG. 8, hydraulic cylinders 20, which are connected via lever rods 63 to the tilting device 64, for tilting the tilting device 64 can be seen. During the pivoting, the angle of attack of the tail propeller 50 is set preferably to zero by means of blade adjustment to facilitate the tilting operation. It is also conceivable to tilt the tail propeller 50 and the stabiliser system 7 independently of one another. FIG. 7 shows a tilted stabilisation system 7 with the tail propeller 50 aligned in the longitudinal direction of the aircraft 65. In FIG. 8, it can moreover be seen how the stabilisation system 7 is supported on the pivoting device 64 by means of struts 19. The stabilisation system 7 comprises tip extensions 11, for improving the aerodynamic quality, which reduce peripheral airflow and thereby reduce the induced resistance. The tip extensions 11 may be a part of the vertical stabiliser surfaces 54.

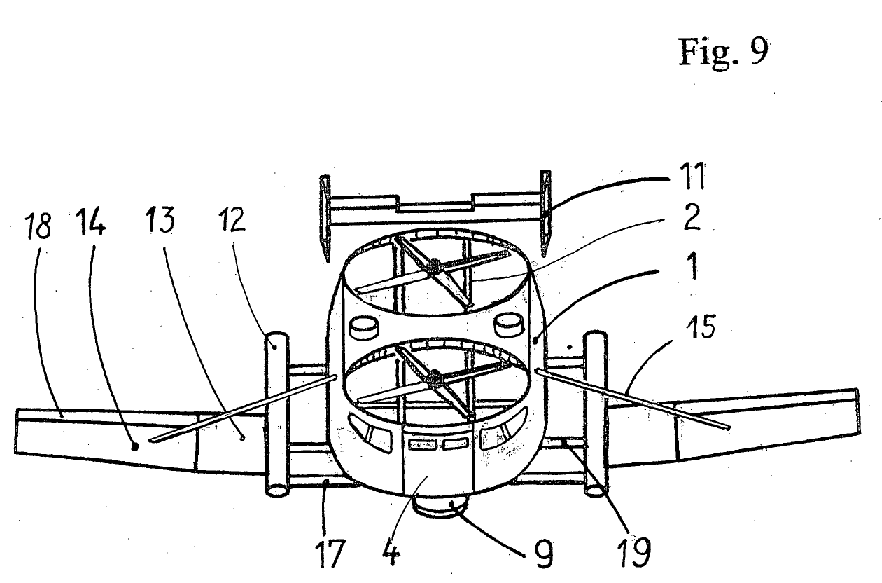

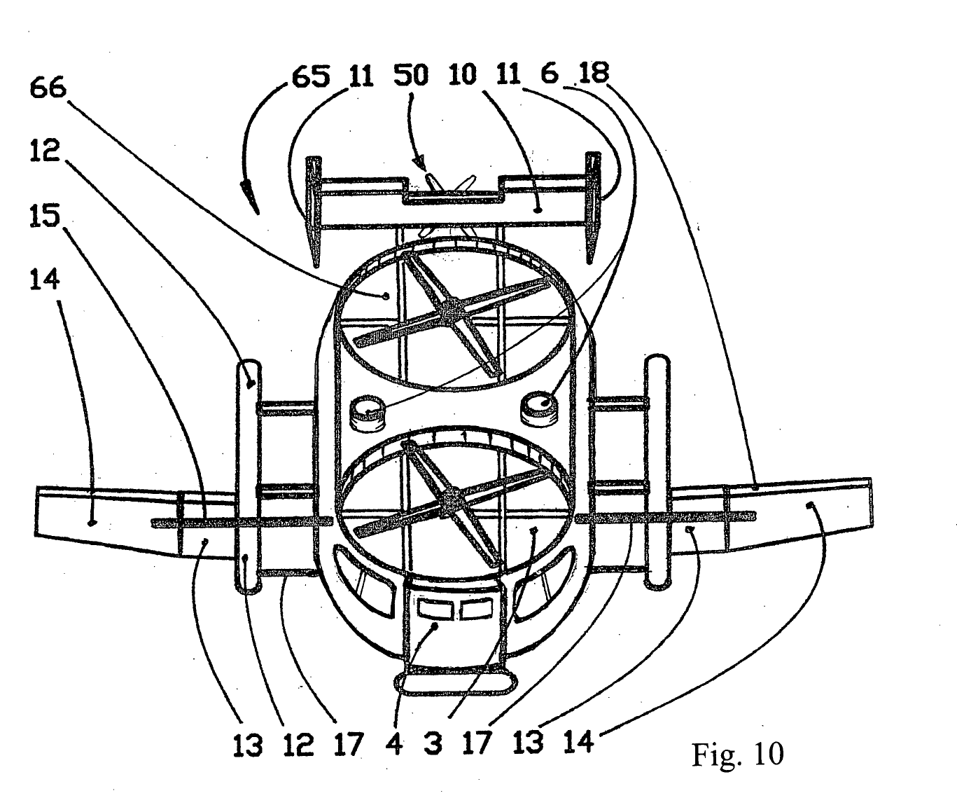

It is also conceivable to connect the stabiliser system 7 rigidly to the base construction with frame 1, as shown in FIGS. 9 and 10, the movable vertical stabiliser surfaces 54 and movable horizontal stabiliser surfaces 10 being provided on the stabiliser system for controlling the aircraft 65 about its vertical and transverse axis.

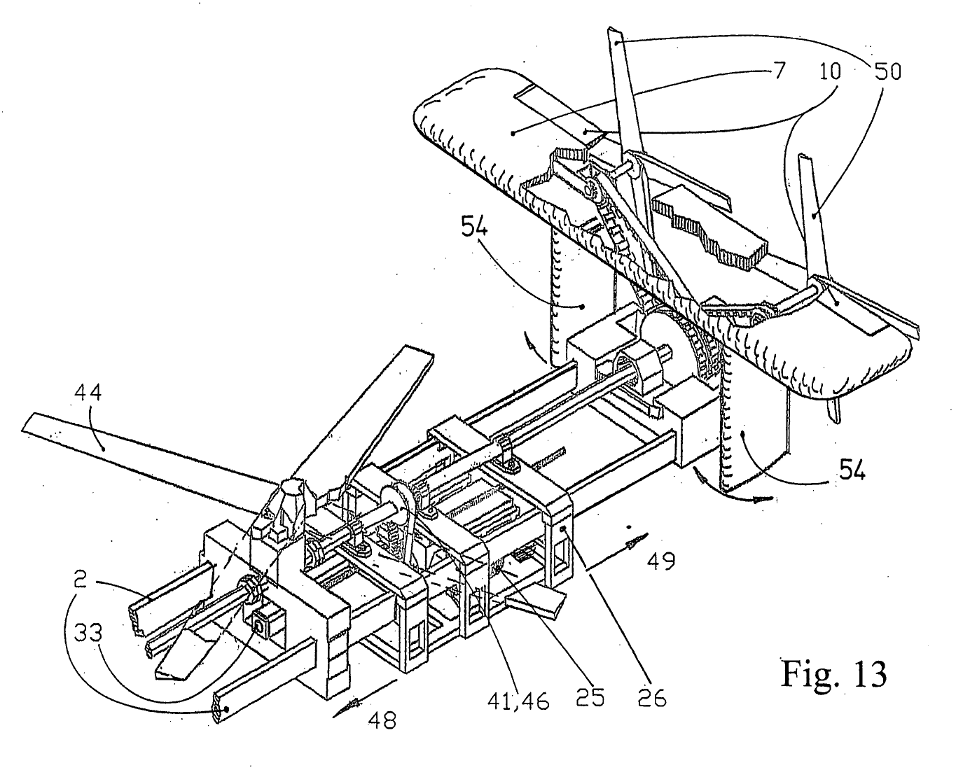

Another possibility for controlling the aircraft 65 about its vertical axis is conceivable by mounting two independent drive engines 8 with associated tail propellers 50 (FIG. 13). In such a case, the tail propeller 50 can also be arranged on the stabiliser system 7. By this means, it is possible to control the aircraft 65 about its vertical axis by varying the rotational speed and/or the angle of attack of the propeller blades of one of the two tail propellers 50. Hence, it is optionally possible to dispense with the stabiliser system 7 entirely.

A further embodiment of the drive of the tail propeller 50 can be derived from FIG. 13.

As can be seen in FIG. 13, one tail propeller 50 in each case is arranged to the left and right on the stabiliser system 7. The drive power for the two tail propellers 50 is, in the embodiment shown in FIG. 13, provided by a second drive engine 25, which is also arranged on an engine-bearing slide 26. This drive engine 25 is connected via an oil coupling 45 optionally to the rear rotor 16 and/or to the two tail propellers 50. By means of the oil coupling 45, the drive engine 25 can be disconnected from the rear rotor 16, when required, for example during straight-ahead flight, by which means the entire drive power of this drive engine 25 is transmitted to the two tail propellers 50. The oil coupling 45 is stabilised by means of a bearing 55 (FIG. 12). The drive of the tail propeller 50 is carried out by means of the drive engine 25, via two toothed-belt pulleys 52, which are arranged axially offset on a drive shaft and can be driven independently of the drive shaft 31, in each case a toothed belt 53, and in each case a gear 51, which translates the rotational speed and direction of rotation of the drive engine 25 to an optimum value for the respective tail propeller 50.

The aircraft can be controlled in this case by separate actuation of the blade adjustment of the two tail propellers 50. Here, too, symmetrically profiled tail propellers are provided to also allow backwards flight. The tail propeller 50 is here not provided only to control the aircraft 65 about its vertical axis, but also as a drive during straight-ahead flight. As from a particular forwards velocity, the two drive engines 25 can be disconnected again from the rotors 16. In this range, the machine flies as a gyrocopter and the rotors act as aerofoils.

FIGS. 9 and 10 show the aircraft 65 with floats 12 on which the aerofoils 14 are supported by means of struts 17. By the use of floats 12, the aircraft 65 can also be used as a flying propeller boat.

By means of the telescopic arm 56, the aircraft 65 can land anywhere. The attachments can be interchanged. It is conceivable to provide hydraulic grippers 61, suction cups 60, pads 62 with soft contact surfaces, for example for landing on pitched house roofs and the like, on the telescopic arms 56. Likewise, an electronic camera 57 can be arranged on the end of a telescopic arm 56, by means of which the movements of the telescopic arm 56 can be monitored. By means of the hydraulic grippers 61, the aircraft 65 can grip securely at poorly accessible and fissured places. The hydraulic grippers 61 are here connected to hydraulic lines 58 with a hydraulic source in the aircraft 65. For the connection of the suction cups 60 to a vacuum source in the aircraft 65, suction lines 59 are provided.

To increase the reliability, in addition to the possibility of disconnecting the rotors 16 from the drive, a collective rotor blade adjustment is provided, by means of which it is possible to carry out an autorotation landing. Moreover, it is also conceivable to arrange two or more rescue parachutes on the aircraft 65. The base construction with frame 1 of the aircraft 65 protects the rotors 16 against contact, and therefore against damage. The tail propeller 50 is here protected by the stabiliser 7. The use of at least two drive engines 25 for drive of the rotors 16 will increase the reliability of the aircraft 65 even more. Depending on the size of the aircraft 65 as many drive engines 25 as desired can be provided.

### List of Reference Numbers

1 Base construction with frame
2 Main bearing rail
3 Crossbeam
4 Cockpit
5 Runner
6 Fuel tank
7 Stabiliser system
8 Drive engine
9 Contact surface
10 Horizontal stabiliser surface
11 Tip extension
12 Float
13 Wing receptacle
14 Aerofoil
15 Strut
16 Rotor
17 Strut
18 Control surface
19 Strut
20 Hydraulic cylinder
21 Front jet deflection, left
22 Front jet deflection, right
23 Rear jet deflection, right
24 Rear jet deflection, left
25 Drive engine
26 Engine bearing slide
27 Oil coupling
28 Toothed-belt pulley
29 Engine carburettor
30 Exhaust silencer
31 Drive shaft
32 Dog clutch
33 Stepping motor for displacing the engine bearing slide
34 Feed rod for displacing the engine bearing slide
35 Bearing
36 Bearing
37 Bearing
38 Spacer sleeve
39 Spacer sleeve
40 Spacer sleeve
41 Toothed-belt pulley
42 Angular gear
43 Angular gear mount
4 Rotor blades
45 Oil coupling
46 Toothed belt with pulley
47 Cylinder rollers
48 Forward pull direction towards the cockpit
49 Backward pull direction towards the tail
50 Tail propeller
51 Gear
52 Toothed-belt pulleys
53 Toothed belt
54 Vertical stabiliser surface
55 Bearing
56 Telescopic arm
57 Camera
58 Hydraulic lines
59 Suction line
60 Suction plate
61 Hydraulic grippers
62 Pad with soft contact surfaces (for landing on pitched house roofs)
63 Lever rods
64 Tilting device
65 Aircraft
66 Rotor pivot opening

1-22. (canceled)

23. A vertical take-off and landing aircraft, comprising:
means for generating lift comprising at least one drivable rotor mounted to be rotatable about a rotor pivot axis extending parallel to a vertical axis of said vertical take-off and landing aircraft;
means for generating propulsion; and,
means for displacing a center of gravity for said vertical take-off and landing aircraft within a plane extending normal to said rotor pivot axis.

24. The vertical take-off and landing aircraft according claim 23, wherein the center of gravity of said vertical take-off and landing aircraft is varied via means for displacing an engine block of said vertical take-off and landing aircraft.

25. The vertical take-off and landing aircraft according claim 23, wherein the center of gravity of said vertical take-off and landing aircraft is varied via means for displacing a tail engine of said vertical take-off and landing aircraft.

26. The vertical take-off and landing aircraft according claim 23, wherein the center of gravity of said vertical take-off and landing aircraft is varied via means for displacing a tank filled with fuel or extinguisher powder for said vertical take-off and landing aircraft.

27. The vertical take-off and landing aircraft according claim 23, wherein means for generating propulsion include at least one drivable propeller rotatable about a propeller axis running perpendicular to a rotor axis.

28. The vertical take-off and landing aircraft according claim 23, wherein said at least one drivable propeller includes means for blade adjustment.

29. The vertical take-off and landing aircraft according claim 23, further comprising means for controlling said vertical take-off and landing aircraft about its vertical axis running parallel to said rotor pivot axis.

30. The vertical take-off and landing aircraft according claim 29, wherein said means for controlling said vertical take-off and landing aircraft about its vertical axis includes a tilting device tiltable about a tilt axis extending parallel to said rotor pivot axis.

31. The vertical take-off and landing aircraft according claim 29, wherein said means for controlling said vertical take-off and landing aircraft about its vertical axis includes at least one vertical stabilizer surface tiltable about an axis running parallel to said rotor pivot axis.

32. The vertical take-off and landing aircraft according claim 23, wherein means for generating propulsion includes at least one jet deflection flap for deflecting rotor downdraught.

33. The vertical take-off and landing aircraft according claim 23, wherein said means for generating lift further includes aerodynamically profiled aerofoils.

34. The vertical take-off and landing aircraft according claim 23, further comprising means for controlling said vertical take-off and landing aircraft about its lateral axis.

35. The vertical take-off and landing aircraft according claim 34, wherein said means for controlling said vertical take-off and landing aircraft about its lateral axis includes means for displacing the center of gravity of said vertical take-off and landing aircraft.

36. The vertical take-off and landing aircraft according claim 23, further comprising means for controlling said vertical take-off and landing aircraft about its transverse axis having at least one horizontal stabilizer surface tiltable parallel to said transverse axis.

37. The vertical take-off and landing aircraft according claim 23, further comprising means for switching “off” said at least one drivable rotor when airspeed exceeds a predetermined minimum value and means for switching “on” said at least one drivable rotor when the airspeed is less than a predetermined minimum value.

38. The vertical take-off and landing aircraft according claim 23, wherein said at least one drivable rotor includes a collective rotor blade adjustment for simultaneous variation of an angle of attack for all rotor blades of said at least one drivable rotor.

39. The vertical take-off and landing aircraft according claim 23, wherein said means for generating lift includes at least two drivable rotors rotatable about a substantially vertical rotor pivot axis for each of said at least two drivable rotors.

40. The vertical take-off and landing aircraft according claim 23, wherein said means for generating propulsion further includes a cyclic rotor blade adjustment for said at least one drivable rotor.

41. The vertical take-off and landing aircraft according claim 23, further comprising a frame surrounding said at least one drivable rotor, said frame having a circular rotor pivot opening continuous in a direction of said rotor pivot axis and wherein said at least one drivable rotor is arranged.

42. The vertical take-off and landing aircraft according claim 41, wherein the circular rotor pivot opening is flared divergently from a cross-section in which said at least one drivable rotor is located.

43. The vertical take-off and landing aircraft according claim 23, further comprising means for landing comprising a telescopic arm.
